(19) United States
(12) Patent Application Publication
(10) Pub. No.: US 2013/0026820 A1
(43) Pub. Date: Jan. 31, 2013

(54) ANTENNA APPARATUS AND WIRELESS COMMUNICATION APPARATUS

(71) Applicants: Katsumi Gocho, Shizuoka-ken (JP); Hiroki Mochizuki, Shizuoka-ken (JP)

(72) Inventors: Katsumi Gocho, Shizuoka-ken (JP); Hiroki Mochizuki, Shizuoka-ken (JP)

(73) Assignee: TOSHIBA TEC KABUSHIKI KAISHA, Tokyo (JP)

(21) Appl. No.: 13/553,978

(22) Filed: Jul. 20, 2012

(30) Foreign Application Priority Data
Jul. 29, 2011 (JP) 2011-166745

(51) Int. Cl. H02J 3/02

(52) U.S. Cl. 307/2

(57) ABSTRACT

According to one embodiment, an antenna apparatus comprises a leaky coaxial cable, an superposing circuit, a separation circuit, a terminator and an electrical apparatus. The superposing circuit configured to superpose a high frequency signal with a direct-current voltage and supply a transmission signal as the superposition result to the first end of the leaky coaxial cable. The separation circuit that is connected with the second end of the leaky coaxial cable and separates the high frequency signal and the direct-current voltage from the transmission signal transmitted through the leaky coaxial cable. The terminator configured to terminate the high frequency signal separated by the separation circuit. The electrical apparatus that is arranged nearby the second end of the leaky coaxial cable and is actuated by the direct-current voltage separated by the separation circuit.

### CROSS-REFERENCE TO RELATED APPLICATION

This application is based upon and claims the benefit of priority from Japanese Patent Application No. 2011-166745, filed Jul. 29, 2011, the entire contents of which are incorporated herein by reference.

### FIELD

Embodiments described herein relate to an antenna apparatus and a wireless communication apparatus.

### BACKGROUND

In an antenna apparatus or wireless communication apparatus using a leaky coaxial cable as an antenna, when electrical apparatus are to be dispersedly arranged nearby two ends of a leaky coaxial cable, the leaky coaxial cable and a feed cable for supplying an actuation voltage to the electrical apparatus are respectively provided.

### BRIEF DESCRIPTION OF THE DRAWINGS

FIG. 1 is a cubic diagram showing a wireless communication apparatus involved in an embodiment;

FIG. 2 is a cross-section diagram showing one part of a wireless communication apparatus involved in an embodiment.

### DETAILED DESCRIPTION

According to one embodiment, an antenna apparatus comprises a leaky coaxial cable, an superposing circuit, a separation circuit, a terminator and an electrical apparatus. The superposing circuit configured to superpose a high frequency signal with a direct-current voltage and supply a transmission signal as the superposition result to the first end of the leaky coaxial cable. The separation circuit that is connected with the second end of the leaky coaxial cable and separates the high frequency signal and the direct-current voltage from the transmission signal transmitted through the leaky coaxial cable. The terminator configured to terminate the high frequency signal separated by the separation circuit. The electrical apparatus that is arranged nearby the second end of the leaky coaxial cable and is actuated by the direct-current voltage separated by the separation circuit.

An example of the embodiment is described below with reference to accompanying drawings.

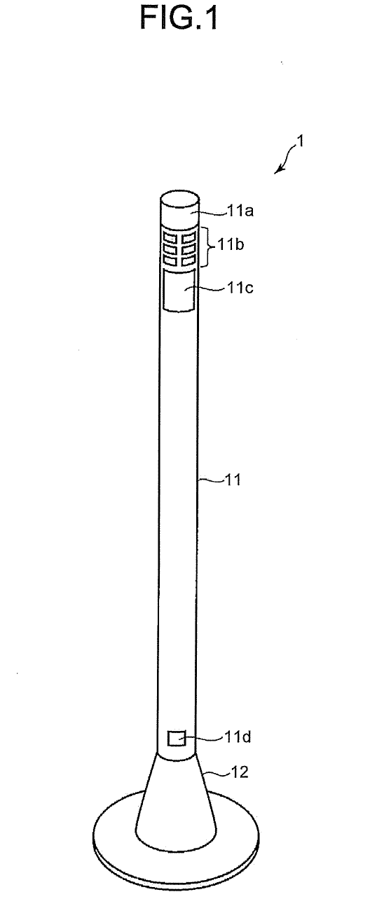

FIG. 1 is a cubic diagram showing a wireless communication apparatus 1 involved in this embodiment.

The wireless communication apparatus 1 comprises a cover 11 and a support table 12.

The cover 11 takes the shape of a slender cylinder. A light-giving window 11a, a vent hole set 11b and a display window 11c are respectively arranged at one end of the cover 11. A sensor window 11d is arranged at the other end of the cover 11. Light transmits through the light-giving window 11a. The vent hole set 11b is an element having a plurality of ventilation openings thereon. The display window 11c is a transparent window. Infrared rays transmit through the sensor window 11d. Further, the light-giving window 11a, the vent hole set 11b, the display window 11c and the sensor window 11d can be freely changed in both position and shape.

The support table 12 has a flat bottom side that is connected with the bed surface of the wireless communication apparatus 1 at a setting position. In order to make the length direction of the cover 11 face a direction that is substantially orthogonal to the bottom side of the support table 12, the support table 12 is provided with the end part of the sensor window 11d of the cover 11.

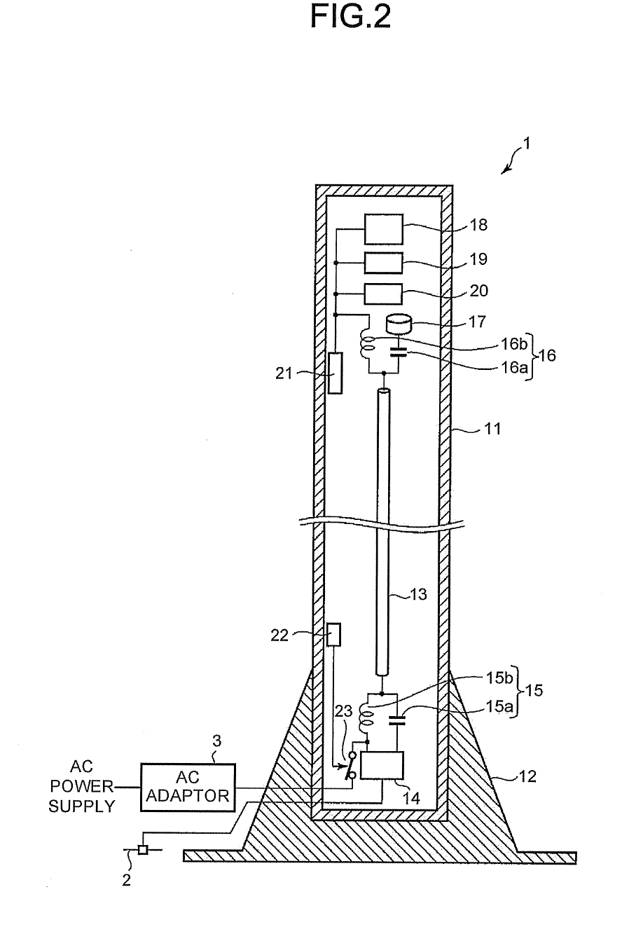

FIG. 2 is a cross-section diagram showing one part of the wireless communication apparatus 1. In addition, the members shown in FIG. 2 identical to those shown in FIG. 1 are represented by the same reference symbols.

FIG. 2 shows a longitudinal section of the cover 11 and the support table 12. As shown in FIG. 2, the cover 11 is hollow. The light-giving window 11a, the vent hole set 11b, the display window 11c and the sensor window 11d are not shown in FIG. 2. The cover 11 is equipped with elements (not shown in FIG. 2) for supporting the components arranged in the cover 11.

In addition to the cover 11 and the support table 12, the wireless communication apparatus 11 further comprises a leaky coaxial cable (LCX) 13, a wireless circuit 14, bias-tees 15 and 16, a terminator 17, an LED indicator light 18, an aroma diffuser 19, a Picoion generator 20, a display 23, a human body sensor 22 and a power switch 23, each of which is arranged in the hollow space of the cover 11. Further, the rough positions and the electrical connection state of the components arranged inside the cover 11 are shown in FIG. 2.

The LCX cable 13 transmits the high frequency signal fed from one end to the other end, and synchronously radiates, from a slot arranged in the middle of the LCX cable 13, part of the energy of the high frequency signal as electric wave. Further, the LCX cable 13 transmits the high frequency signal that is generated by the surrounding electromagnetic waves. The LCX cable 13 is arranged in a substantially linear form along the length direction of the cover 11.

The wireless circuit 14 is connected with such a communication line 2 as an LAN (Local Area Network) line and generates a high frequency signal for wirelessly transmitting the transmission data received through the communication line 2 from the LCX cable 13. Further, the wireless circuit 14 extracts the transmission data from the high frequency signal generated by the LCX cable 13 and sends the extracted transmission data to the communication line 2. The wireless circuit 14 feeds, through the power switch 23, an AC adaptor 3 the direct-current voltage generated from an AC power supply, and is actuated by taking the direct-current voltage as an actuation voltage.

The bias 15 comprises a capacitor 15a and an inductor 15b. One end of the capacitor 15a, one end of the inductor 15b and the first end of the LCX cable 13 are connected with each other. The other end of the capacitor 15a is connected with the high frequency signal input-output terminal of the wireless circuit 14. The direct-current voltage output by the AC adaptor 3 is fed at the other end of the inductor 15b through the power switch 23.

The bias 16 comprises a capacitor 16a and an inductor 16b. One end of the capacitor 16a, one end of the inductor 16b and the second end of the LCX cable 13 are connected with each other. The other end of the capacitor 16a is connected with the terminator 17. The other end of the inductor 16b is connected with the power terminals of the LED light 18, the aroma diffuser 19, the Picoion generator 20 and the display 23.

Typically, the terminator 17 is a resistor matching with the resistance at the second end of the LCX 13 to restrict the reflection of the high frequency signal in the second end.

The LED indicator light 18, as a light source, comprises an LED (Light Emitting Diode), and is arranged to transmit the light emitted by the LED to the outside of the cover 11 through the light-giving window 11. By changing light-giving state, the LED indicator light 18 displays the action state of the wireless communication apparatus 1.

The aroma diffuser 19 generates an aromatic compound.

The Picoion generator 20 generates fine ions.

Air containing the compound generated by the aroma diffuser 19 and the ions generated by the Picoion generator 20 is released to the outside of the cover 11 through the vent hole set 11b.

The display 21 displays various images, videos and words. With a display panel facing the display window 11c, the display 21 enables the images, videos and words displayed thereon to be seen from the outside of the cover 11 through the display window 11c. The display 21 may be a well-known display such as an LCD (Liquid Crystal Display).

The human body sensor 22 detects a person approaching the wireless communication apparatus using infrared rays and outputs a detection signal indicative of whether or not a person is detected. The human body sensor 22 may be replaced with a apparatus which detects a person using, for example, ultrasonic waves rather than infrared rays.

The power switch 23 is switched on/off according to the detection signal output from the human body sensor 22.

Next, the actions of the wireless communication apparatus 1 with the structure above are described below.

If a person approaching the wireless communication apparatus 1 is detected by the human body sensor 22, the power switch 23 is switched on. Thus, the wireless circuit 14 is fed with the direct-current voltage output by the AC adaptor 13 and then acts.

The high frequency signal output from the input-output terminal of the wireless circuit 14 flows through the capacitor 15a but not through the inductor 15b. On the other hand, the direct-current voltage output from the AC adaptor flows through the inductor 15b but not through the capacitor 15a. In this way, a transmission signal in which a direct-current voltage is superposed with a high frequency signal is generated by the bias 15. That is, the bias 15 acts as a superposing circuit.

If fed with the transmission signal from the bias 15 at the first end, the LCX cable 13 transmits the transmission signal to the second end, and synchronously radiates part of the energy of the high frequency signal contained in the transmission signal as electric waves. Further, the high frequency signal contained in the transmission signal that is not radiated as electric waves flows through the capacitor 16a and are terminated by the terminal 17. On the other hand, the high frequency signal generated in the LCX cable 13 from the electric waves around the LCX cable 13 flows through the capacitor 15a in the bias 15, and is then fed to the input-output terminal of the wireless circuit 14. In this way, the wireless terminal nearby the wireless communication apparatus 1 may access a communication line 2 through the wireless communication apparatus 1. That is, the wireless communication apparatus 1 may act as a wireless access point.

On the other hand, the direct-current voltage contained in the transmission signal flows through the inductor 16b in the bias 16 and is then fed to the power terminals of the LED light 18, the aroma diffuser 19, the Picoion generator 20 and the display 21. In this way, the LED light 18, the aroma diffuser 19, the Picoion generator 20 and the display 21 are fed with an actuation voltage to act. Thus, the bias 16 separates the high frequency signals from the direct-current voltage contained in the transmission signal and acts as a separation circuit.

Moreover, the high frequency signal is stopped by the inductors 15b and 16b and is thus not fed to the power terminals of the wireless circuit 14, the LED indicator light 18, the aroma diffuser 19, the Picoion generator 20 and the display 21 or the output terminal of the AC adaptor 3. Thus, the voltage supplied to the wireless circuit 14, the LED indicator light 18, the aroma diffuser 19, the Picoion generator 20 and the display 21 maintains invariable, which eliminates an abnormality caused by a power supply variation caused by the high frequency signal. Besides, no high frequency signal is input to the output terminal of the AC adaptor 3, thus eliminating the troubles caused by the generation of a high frequency signal by the AC adaptor 3.

As stated above, in the wireless communication apparatus 1, the feed cable for supplying an actuation voltage to the LED indicator light 18, the aroma diffuser 19, the Picoion generator 20 and the display 21 is not arranged parallel to the LCX cable 13, which provides an orderly internal space in the cover 11 when compared with the situation in which the feed cable is arranged parallel to the LCX cable 13.

Further, in the wireless communication apparatus 1, the LCX cable 13, the bias 16 and the terminator '7 are covered by the cover 11 and are therefore difficult to modify, thus preventing an illegal modification.

Further, in the wireless communication apparatus 1, the supply of a direct-current voltage to the bias 15 is stopped when there is no person nearby the wireless communication apparatus 1, thus, power consumption is lowered. Moreover, in this embodiment, as the LED indicator light 18, the aroma diffuser 19, the Picoion generator 20 and the display 21 are all apparatus that provide services for a person close to the wireless communication apparatus 1, the shutdown of these apparatus in the case of no person to be served will cause no troubles.

This embodiment may be embodied in the following forms.

The antenna apparatus may also be achieved without the wireless circuit 14.

The electrical apparatus actuated by the direct-current voltage separated by the bias 16 may comprise only part of the LED indicator light 18, the aroma diffuser 19, the Picoion generator 20 and the display 21 or comprise various other elements rather than those above. That is, the electrical apparatus actuated by the direct-current voltage separated by the bias 16 may comprise at least one of the LED indicator light 18, the aroma diffuser 19, the Picoion generator 20, the display 21 and the apparatus different from the elements above.

A direct-current voltage may be fed to the wireless circuit 14 without using the power switch 23.

The human body sensor 22 and the power switch may not be arranged on the wireless communication apparatus 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna apparatus, comprising:
a leaky coaxial cable;
an superposing circuit configured to superpose a high frequency signal with a direct-current voltage and supply a transmission signal as the superposition result to the first end of the leaky coaxial cable;
a separation circuit that is connected with the second end of the leaky coaxial cable and separates the high frequency signal and the direct-current voltage from the transmission signal transmitted through the leaky coaxial cable;
a terminator configured to terminate the high frequency signal separated by the separation circuit; and
an electrical apparatus that is arranged nearby the second end of the leaky coaxial cable and is actuated by the direct-current voltage separated by the separation circuit.

2. The antenna apparatus according to claim 1, wherein
the superposing circuit includes:
a first preventing element configured to prevent the flow of the high frequency signal to the supply side of the direct-current voltage; and
a second preventing element configured to prevent the flow of the direct-current voltage to the supply side of the high frequency signal.

3. The antenna apparatus according to claim 2, wherein
the superposing circuit is a circuit connected with one end of an inductor serving as the first preventing element and one end of a capacitor serving as the second preventing element.

4. The antenna apparatus according to claims 1, further comprising:
a cover configured to cover the leaky coaxial cable; the separation circuit and the terminator.

5. The antenna apparatus according to claims 1, further comprising:
a human body sensor arranged to detect a person approaching; and
a switch arranged to switch off the input of the direct-current voltage to the superposing circuit when the person approaching is not detected by the human body sensor.

6. A wireless communication apparatus, comprising:
a leaky coaxial cable;
a wireless circuit configured to generate a high frequency signal for the wireless communication;
an superposing circuit configured to superpose a high frequency signal with a direct-current voltage and supply a transmission signal as the superposition result to the first end of the leaky coaxial cable;
a separation circuit that is connected with the second end of the leaky coaxial cable and separates the high frequency signal and the direct-current voltage from the transmission signal transmitted through the leaky coaxial cable;
a terminator configured to terminate the high frequency signal separated by the separation circuit; and
an electrical apparatus that is arranged nearby the second end of the leaky coaxial cable and is actuated by the direct-current voltage separated by the separation circuit.
